(19) United States
(12) Patent Application Publication
(10) Pub. No.: US 2014/0188997 A1
(43) Pub. Date: Jul. 3, 2014

(54) Creating and Sharing Inline Media Commentary Within a Network

(71) Applicants: Henry Will Schneiderman, Pittsburgh, PA (US); Michael Andrew Sipe, Pittsburgh, PA (US); Steven James Ross, Allison Park, PA (US); Brian Ronald Colonna, Pittsburgh, PA (US); Danielle Marie Millett, Pittsburgh, PA (US); Uriel Gerardo Rodriguez, Sandy Springs, GA (US); Michael Christian Nechyba, Pittsburgh, PA (US); Mikkel Crone Köser, Frederiksberg C (DK); Ankit Jain, Mountain View, CA (US)

(72) Inventors: Henry Will Schneiderman, Pittsburgh, PA (US); Michael Andrew Sipe, Pittsburgh, PA (US); Steven James Ross, Allison Park, PA (US); Brian Ronald Colonna, Pittsburgh, PA (US); Danielle Marie Millett, Pittsburgh, PA (US); Uriel Gerardo Rodriguez, Sandy Springs, GA (US); Michael Christian Nechyba, Pittsburgh, PA (US); Mikkel Crone Köser, Frederiksberg C (DK); Ankit Jain, Mountain View, CA (US)

(21) Appl. No.: 13/732,264

(22) Filed: Dec. 31, 2012

(51) Int. Cl. H04L 12/58

(52) U.S. Cl. CPC H04L 51/10
USPC 709/204

(57) ABSTRACT

The present disclosure includes systems and methods for creating and sharing inline commentary relating to media within an online community, for example, a social network. The inline commentary can be one or more types of media, for example, text, audio, image, video, URL link, etc. In some implementations, the systems and methods either receive media that is live or pre-recorded, permit viewing by users and receive selective added commentary by users inline. The systems and methods are configured to send one or more notifications regarding the commentary. In some implementations, the systems and methods are configured to receive responses by other users to the initial commentary provided by a particular user.

### BACKGROUND

The present disclosure relates to technology for creating and sharing inline media commentary between users of online communities or services, for example, social networks.

The popularity of commenting on online media has grown dramatically over the recent years. Users may add personal or shared media to an online server for consumption by an online community. Currently, users comment on media via text, which is separate from the media and flows along a distinct channel. It is difficult to add various types of commentary media to online media inline and share this commentary with other users, especially select users consuming the media that are connected in a network.

### SUMMARY

In one innovative aspect, the present disclosure of the technology includes a system comprising: a processor and a memory storing instructions that, when executed, cause the system to: receive media for viewing by a plurality of users of a network, wherein the media includes at least one of live media and pre-recorded media; receive commentary added by one or more of the plurality of users to the media, at a point, wherein the point is at least one of a group of 1) a selected play-point within the media, 2) a portion within the media, and 3) an object within the media; store the media and the commentary; selectively share the commentary with one or more users within the network who are selected by a particular user; enable viewing of the commentary by the one or the more users with whom the commentary is shared; and receive a comment on the commentary including at least one of a group of 1) text, 2) a photograph, 3) video, 4) audio, 5) a link to other content, and 6) insertion of text and modification to any visual-based, audio-based, and text-based component of the media.

In general, another innovative aspect of the present disclosure includes a method, using one or more computing devices for: receiving media for viewing by a plurality of users of a network wherein the media includes at least one of live media and pre-recorded media; receiving commentary added by one or more users to the media at a point, wherein the point includes at least one of a group of 1) a selected play-point within the media, 2) a portion of the media, and 3) an object within the media; storing the media and the commentary; selectively sharing the commentary with one or more users within the network who are selected by a particular user; enable viewing of the commentary by the one or the more users with whom the commentary is shared; and receiving at least one comment on the commentary including at least one of a group of 1) text, 2) a photograph, 3) video, 4) audio, 5) a link to other content, and 6) insertion of text and modification to any visual-based, audio-based, and text-based component of the media.

Other implementations of one or more of these aspects include corresponding systems, apparatus, and computer programs, configured to perform the action of the methods, encoded, on computer storage devices.

These and other implementations may each optionally include one or more of the following features in the system, including instructions stored in the memory that cause the system to further: i) process notifications to select users of the network, on the commentary added to the media, wherein the notifications are processed in at least one of the following ways: receive from users of the network when the users post commentary; send the notifications when the commentary is added; provide the notifications for display on a plurality of computing and communication devices; and provide the notifications via a software mechanism including at least one of a group of email, instant messaging, social network software, software for display on a home screen of a computing or communication device; ii) link commentary to particular entities specified by metadata within the media, wherein the media is at least one of video, audio, and text, and an entity in the video includes at least one of a group of 1) a specific actor, 2) a subject, 3) an object, 4) a location, 5) audio content, and 6) a scene in the media, and an entity in the audio including audio content and a scene, and an entity in the text including a portion of the text; iii) wherein the metadata is created by at least one of manual and automatic operations, and the automatic operations include at least one of 1) face recognition, 2) speech recognition, 3) audio recognition, 4) optical character recognition, 5) computer vision, 6) image processing, 7) video processing, 8) natural language understanding, and 9) machine learning; iv) wherein the media is at least one of video, audio, or text; v) select and share portions of the media with the commentary with the one or more users within the network who are selected by a particular user; vi) indicate restrictions on sharing specific portions of the media; indicate restrictions on at least one of 1) a length, 2) extent, and 3) duration of the media designated for sharing; indicate restrictions on viewing of a total amount of portions of the media by the one or more users after it is selected for sharing by the particular user; maintain a record of user consumption history on shared media; vii) restrict an amount of media for free consumption by a user that is selected for sharing by the particular user; and viii) restrict an amount of media for consumption by a specific user that is selected for sharing by the particular user; ix) enable viewing of the media by a particular user with other select users in the network; and x) enable the users of the network to provide rating relating to the commentary added to the media and enabling viewing of the ratings by the users.

For instance, the operations further include one or more of: i) processing notifications to select users of the network, on the commentary added to the media, wherein the notifications are processed in at least one of the following ways: receiving notifications from users of the network when the users post commentary; sending the notifications when the commentary is added; providing the notifications for display on a plurality of computing and communication devices; providing the notifications via a software mechanism including at least one of a group of email, instant messaging, social network software, software for display on a home screen of a computing or communication device; ii) linking commentary to particular entities specified by metadata within the media, wherein the media is at least one of 1) video, 2) audio, and 3) text, and an entity in the video includes at least one of a group of 1) a specific actor, 2) a subject, 3) an object, 4) a location, 5) audio content, and 6) a scene in the media, and an entity in the audio includes audio content and a scene, and an entity in the text includes a portion of the text; iii) wherein the metadata is created by at least one of manual and automatic operations, and the automatic operations include at least one of 1) face recognition, 2) speech recognition, 3) audio recognition, 4) optical character recognition, 5) computer vision, 6) image processing, 7) video processing, 8) natural language understanding, and 9) machine learning; iv) wherein the media is at least one of video, audio, or text; v) selecting and sharing portions of the media with the commentary with the one or more users within the network who are selected by a particular user; vi) indicating restrictions on sharing specific portions of the media; indicating restrictions on at least one of a length, extent, and duration of the media designated for sharing; vii) indicating restrictions on viewing of a total amount of portions of the media by the one or more users after it is selected for sharing by the particular user; maintaining a record of user consumption history on shared media; viii) restricting an amount of media for free consumption by a user that is selected for sharing by the particular user; ix) restricting an amount of media for consumption by a specific user that is selected for sharing by the particular user; x) enabling viewing of the media by a particular user with other select users in the network; and enabling the users of the network to provide rating relating to the commentary added to the media and enabling viewing of the ratings by the users.

The systems and methods disclosed below are advantageous in a number of respects. With the ongoing trends and growth in communications over a network, for example, social network communication, it may be beneficial to generate a system for commenting inline on various types of media within an online community. The systems and methods provide ways for adding commentary at certain play points on the online media and sharing the commentary with one or more select users of the online community.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a block diagram illustrating an example system for adding and sharing media commentary, for example, adding alternate dialog to a video, including a media commentary application.

FIG. 2 is a block diagram illustrating example hardware components in some implementations of the system shown in FIG. 1.

FIG. 3 is a block diagram illustrating an example media commentary application and its software components.

FIG. 4 is a flowchart illustrating an example method for creating and sharing inline media commentary.

FIG. 5 is a flowchart illustrating an example method for selecting and sharing media clips.

FIG. 6 is a flowchart illustrating an example method for determining facial similarities.

FIG. 7 is a flowchart illustrating an example method for playing media clips during a media conference.

FIG. 8 is a graphic representation of an example user interface for adding commentary to a video via an interface within the video player.

FIG. 9 is a graphic representation of an example user interface for adding commentary to a video via an interface external to the video player.

FIG. 10 is a graphic representation of an example user interface for displaying text commentary in a video.

FIG. 11 is a graphic representation of an example user interface for displaying video commentary in a video.

FIG. 12 is a graphic representation of an example user interface for displaying image commentary in a video.

FIG. 13 is a graphic representation of an example user interface for playing audio commentary in a video.

FIG. 14 is a graphic representation of an example user interface for displaying link commentary in a video.

FIG. 15 is a graphic representation of an example user interface for displaying videos via a user interface.

FIG. 16 is a graphic representation of an example user interface for displaying commentary in a text article.

FIG. 17 is a graphic representation of an example user interface for notifying a user of facial similarities.

FIG. 18 is a graphic representation of an example user interface for displaying a video during a video conference.

### DETAILED DESCRIPTION

In some implementations, the technology includes systems and methods for sharing inline media commentary with members or users of a network (e.g., a social network or any network (single or integrated) configured to facilitate viewing of media). For example, a user may add commentary (e.g., text, audio, video, link, etc.) to live or recorded media (e.g., video, audio, text, etc.). The commentary may then be shared with members of an online community, for example, a social network, for consumption. The commentary application may be built into or configured within a media player, or configured to be external to the media player.

As one example, a user A may watch a motion picture (“movie”), add commentary to it, at specific points to label a particularly interesting portion or entity in the movie and may share it with user B. A notification about the commentary by user A is generated and provided to user B (e.g., a friend or associate of user A). User B may view the commentary on a network (by which user B is connected to user A, for example, a social network). The commentary may include a “clip” featuring the particularly interesting portion or entity in the movie. An entity in video-based media may be a specific actor, a subject, an object, a location, audio content, a scene in the media. An entity in audio-based media may be audio content and a scene. An entity in text-based media may be a portion of certain text. User B may concur with User A and decide to watch the movie at a later time when he or she is free. While watching the movie, User B may view user A's commentary, and may respond with his or her own thoughts or comments. This technology simulates an experience for users who may watch a movie with others, even if at a different time and place.

In some implementations, the system may consist of a large collection of media (e.g., recorded media) that can be consumed by users. Users may embed, add, attach, or link commentary or provide labels at chosen points of play, positions or objects within a piece or item of media, for example, indicating a person (e.g., who may be either static or moving or indicated in three-dimensional form). The positions or objects may be any physical entities that are static or moving in time. As an example, a particular user may want to comment on an actor's wardrobe in each scene in a movie. The user may then select members of a social network with whom to share the specific comments (e.g., friends or acquaintances). Notifications may be generated and transmitted for display on a computing or communication device used by users. In some instances, the notifications may be processed in several ways. In some implementations, notifications may be received from users when they post commentary. In some implementations, notifications may be received when the commentary is added. In some implementations, notifications may be provided via software mechanisms including by email, by instant messaging, by social network operating software, by operating software for display of a notification on a user's home screen on the computing or communication device.

The user may also select the method of notification (e.g., by email directly to friends, by broadcast to friends' social network stream, or simply by tagging in the media). During the consumption of media, users may have the option to be notified when they reach particular embedded commentary and choose to view the commentary. In certain situations, users may also “opt” to receive immediate notifications of new commentary by email or instant messaging and be able to immediately view the commentary along with the corresponding media segment. In some instance, if desired, a user may respond to existing commentary. The system may then become a framework for discussions among friends about specific media. This system may also be a means for amateur and professional media reviewers to easily comment on specifics in media and to provide “a study guide” for other consumers.

In some implementations, the system allows users to respond to commentary. For example, a user posts commentary that states that he sees a ghost in the video and another user responds that the ghost is just someone in a bed sheet. Also, the system may send a notification to users (e.g., via email, instant messaging, social stream, video tag, etc.) when commentary is posted to the media.

In some implementations, the commentary may be written comments, but may also take other forms such as visual media (e.g., photos and video), URLs, URLs to media clips, clips from media (e.g., links to start and endpoints), a graphic overlay on top of the (visual) media, a modified version of the media, or an overdubbing of the media audio such as a substitution of dialogue. This broader view of “commentary” differentiates this disclosure from existing systems for sharing written commentary.

Media commentary may include a comment or label that may be attached “inline” to the media. For example, a video comment may be included for a particular number of frames or while the video is paused. A comment can be a text comment that may be included in the media. For instance, a user creates a text that states “This is my favorite part” and may be displayed on a video during a specific scene. A comment may be an image that may be included in a video, or text. For example, a user may notice (in a video or a magazine article) that an actor has undergone plastic surgery and may embed pre-surgery photos of this actor. As another example, a user may “paste” his face over an actor in a video. As yet another example, a user may send a clip of a funny scene from a movie to their friends. A comment can be an audio clip that may be included in the media. For example, a user may substitute his dialog for what is there, by overdubbing the voices of the actors in a particular scene. A comment can be a video clip that may be included in the media. For example, a user may embed a homemade video parody of a particular scene. A comment can be a web link that may be included in the media. For example, a user may embed a web link to an online service, selling merchandise related to the current media. All such commentary may be static, attached to an actor as they move in a scene or multiple scenes, or attached to a particular statement, a set of statements, or a song, using metadata extracted by face or speech recognition.

The metadata may be created by manual or automatic operations including face recognition, speech recognition, audio recognition, optical character recognition, computer vision, image processing, video processing, natural language understanding, and machine learning.

In addition, in some implementations, the commentary interface may be built into the media viewer. In some implementations, in this interface, a user may initiate commentary by executing a pause to the media and selecting a virtual button. The user may then add information (e.g., title, body, attachments, etc.) to the commentary. The user may then determine a period of time the commentary persists in the media (e.g., the length of a scene). A user may compose audio and visual commentary using recording devices and edit applications that merge their commentary with the media. The user finally selects the audience of the comment and broadcasts it. Upon finalizing the commentary, the user may view the media with the commentary.

In other implementations, the commentary interface may be external to the media viewer. This interface may be designed for “heavy” users who may wish to comment widely about their knowledge of various media sources. In this interface, the user selects the media and jumps to the point of play that is of interest. In some implementations, the interface may be the same as the previous interface once the point of play is reached. After the commentary is added, the interface would return to an interface for selecting media. A user may select media from a directory combined with a search box. The interface component for jumping to the point of play of interest may take many forms. For example, if the media is a video, the interface may be a standard DVD (digital video disc) scene gallery that would allow the user to jump to a set of pre-defined scenes in the movie and then search linearly to a point of play of the selected scenes. In a more advanced interface, the user may search for scenes that combine various actors and/or dialog. Such a search would use metadata extracted by face recognition and/or speech recognition. This metadata would only have to be extracted once and attached to the media thereafter.

The system may present the commentary to consumers in a number of ways. For example, if the media is a video, the commentary may be displayed while the original video continues to play, particularly, if the commentary is some modification of the video, for example audio/visual modification of the video. The original video may also be paused and the commentary may be displayed in place of the original content or side by side with it. The commentary may also be displayed on an external device, for example, a tablet, mobile phone, or a remote control.

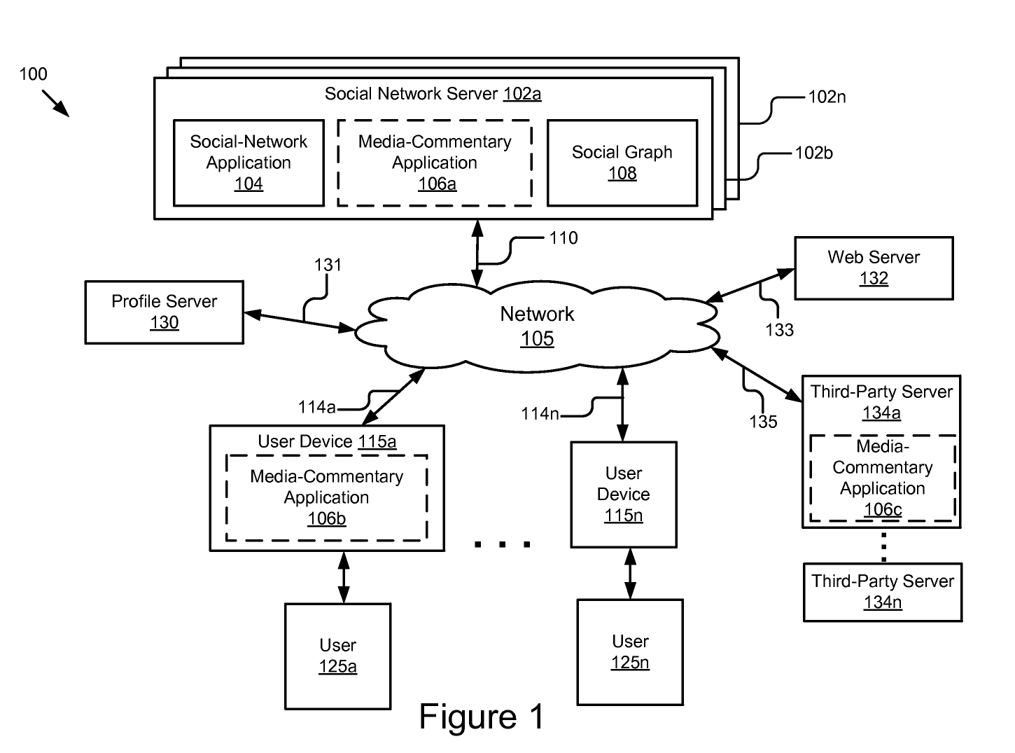

FIG. 1 is a high-level block diagram illustrating some implementations of systems for creating and sharing inline media commentary with an online community, for example, social networks. The system 100 illustrated in FIG. 1 provides system architecture (distributed or other) for creating and sharing inline media commentary containing one or more types of additional media (e.g., text, image, video, audio, URL (uniform resource locator), etc.). The system 100 includes one or more social network servers 102a, 102b, through 102n, that may be accessed via user devices 115a through 115n, which are used by users 125a through 125n, to connect to one of the social network servers 102a, 102b, through 102n. These entities are communicatively coupled via a network 105. Although only two user devices 115a through 115n are illustrated, one or more user devices 115n may be used by one or more users 125n.

Moreover, while the present disclosure is described below primarily in the context of providing a framework for inline media commentary, the present disclosure may be applicable to other situations where commentary for a purpose that is not related to a social network, may be desired. For ease of understanding and brevity, the present disclosure is described in reference to creating and sharing inline media commentary within a social network.

The user devices 115a through 115n in FIG. 1 are illustrated simply as one example. Although FIG. 1 illustrates only two devices, the present disclosure applies to a system architecture having one or more user devices 115, therefore, one or more user devices 115n may be used. Furthermore, while only one network 105 is illustrated as coupled to the user devices 115a through 115n, the social network servers, 102a-102n, the profile server 130, the web server 132, and third party servers 134a through 134n, in practice, one or more networks 105 may be connected to these entities. In addition, although only two third party servers 134a through 134n are shown, the system 100 may include one or more third party servers 134n.

In some implementations, the social network server 102a may be coupled to the network 105 via a signal line 110. The social network server 102a includes a social network application 104, which includes the software routines and instructions to operate the social network server 102a and its functions and operations. Although only one social network server 102a is described here, persons of ordinary skill in the art should recognize that multiple servers may be present, as illustrated by social network servers 102b through 102n, each with functionality similar to the social network server 102a or different.

In some implementations, the social network server 102a may be coupled to the network 105 via a signal line 110. The social network server 102a includes a social network application 104, which includes the software routines and instructions to operate the social network server 102a and its functions and operations. Although only one social network server 102a is described here, multiple servers may be present, as illustrated by social network servers 102b through 102n, each with functionality similar to social network server 102a or different.

The term “social network” as used here includes, but is not limited to, a type of social structure where the users are connected by a common feature or link. The common feature includes relationships/connections, e.g., friendship, family, work, a similar interest, etc. The common features are provided by one or more social networking systems, for example those included in the system 100, including explicitly-defined relationships and relationships implied by social connections with other online users, where the relationships form the social graph 108.

The term “social graph” as used here includes, but is not limited to, a set of online relationships between users, for example provided by one or more social networking systems, for example the social network system 100, including explicitly-defined relationships and relationships implied by social connections with other online users, where the relationships form a social graph 108. In some examples, the social graph 108 may reflect a mapping of these users and how they are related to one another.

The social network server 102a and the social network application 104 as illustrated are representative of a single social network. Each of the plurality of social network servers 102a, 102b through 102n, may be coupled to the network 105, each having its own server, application, and social graph. For example, a first social network hosted on a social network server 102a may be directed to business networking, a second on a social network server 102b directed to or centered on academics, a third on a social network server 102c (not separately shown) directed to local business, a fourth on a social network server 102d (not separately shown) directed to dating, and yet others on social network server (102n) directed to other general interests or perhaps a specific focus.

A profile server 130 is illustrated as a stand-alone server in FIG. 1. In other implementations of the system 100, all or part of the profile server 130 may be part of the social network server 102a. The profile server 130 may be connected to the network 105 via a line 131. The profile server 130 has profiles for the users that belong to a particular social network 102a-102n. One or more third party servers 134a through 134n are connected to the network 105, via signal line 135. A web server 132 may be connected, via line 133, to the network 105.

The social network server 102a includes a media-commentary application 106a, to which user devices 115a through 115n are coupled via the network 105. In particular, user devices 115a through 115n may be coupled, via signal lines 114a through 114n, to the network 105. The user 125a interacts via the user device 115a to access the media-commentary application 106 to either create, share, and/or view media commentary within a social network. The media-commentary application 106 or certain components of it may be stored in a distributed architecture in one or more of the social network server 102, the third party server 134, and the user device 115. In some implementations, the media-commentary application 106 may be included, either partially or entirely, in one or more of the social network server 102, the third party server 134, and the user device 115.

The user devices 115a through 115n may be a computing device, for example, a laptop computer, a desktop computer, a tablet computer, a mobile telephone, a personal digital assistant (PDA), a mobile email device, a portable game player, a portable music player, a television with one or more processors embedded in the television or coupled to it, or an electronic device capable of accessing a network.

The network 105 may be of conventional type, wired or wireless, and may have a number of configurations for example a star configuration, token ring configuration, or other configurations. Furthermore, the network 105 may comprise a local area network (LAN), a wide area network (WAN, e.g., the Internet), and/or another interconnected data path across which one or more devices may communicate.

In some implementations, the network 105 may be a peer-to-peer network. The network 105 may also be coupled to or include portions of one or more telecommunications networks for sending data in a variety of different communication protocols.

In some instances, the network 105 includes Bluetooth communication networks or a cellular communications network for sending and receiving data for example via short messaging service (SMS), multimedia messaging service (MMS), hypertext transfer protocol (HTTP), direct data connection, WAP, email, etc.

In some implementations, the social network servers, 102a-102n, the profile server 130, the web server 132, and the third party servers 134a through 134n are hardware servers including a processor, memory, and network communication capabilities. One or more of the users 125a through 125n access one or more of the social network servers 102a through 102n, via browsers in their user devices and via the web server 132.

As one example, in some implementations of the system, information of particular users (125a through 125n) of a social network 102a through 102n may be retrieved from the social graph 108. It should be noted that information that is retrieved for particular users is only upon obtaining the necessary permissions from the users, in order to protect user privacy and sensitive information of the users.

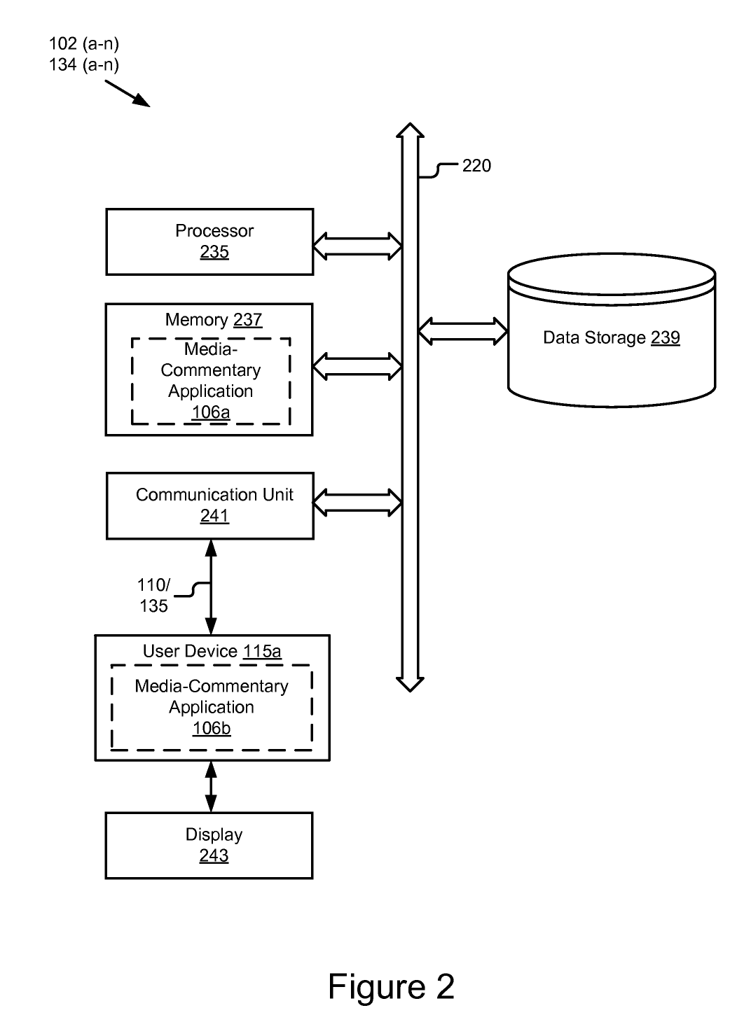

FIG. 2 is a block diagram illustrating some implementations of a social network server 102a through 102n and a third party server 134a through 134n, the system including a media-commentary application 106a. In FIG. 2, like reference numerals have been used to reference like components with the same or similar functionality that has been described above with reference to FIG. 1. Since those components have been described above that description is not repeated here. The system generally includes one or more processors, although only one processor 235 is illustrated in FIG. 2. The processor may be coupled, via a bus 220, to memory 237 and data storage 239, which stores commentary information, received from the other sources identified above. In some instances, the data storage 239 may be a database organized by the social network. In some instances, the media-commentary application 106 may be stored in the memory 237.

A user 125a, via a user device 115a, may either create, share, and/or view media commentary within a social network, via communication unit 241. In some implementations, the user device may be communicatively coupled to a display 243 to display information to the user. The media-commentary application 106a and 106c may reside, in their entirety or parts of them, in the user's device (115a through 115n), in the social network server 102a (through 102n), or, in a separate server, for example, in the third party server 134 (FIG. 1). The user device 115a communicates with the social network server 102a using the communication unit 241, via signal line 110.

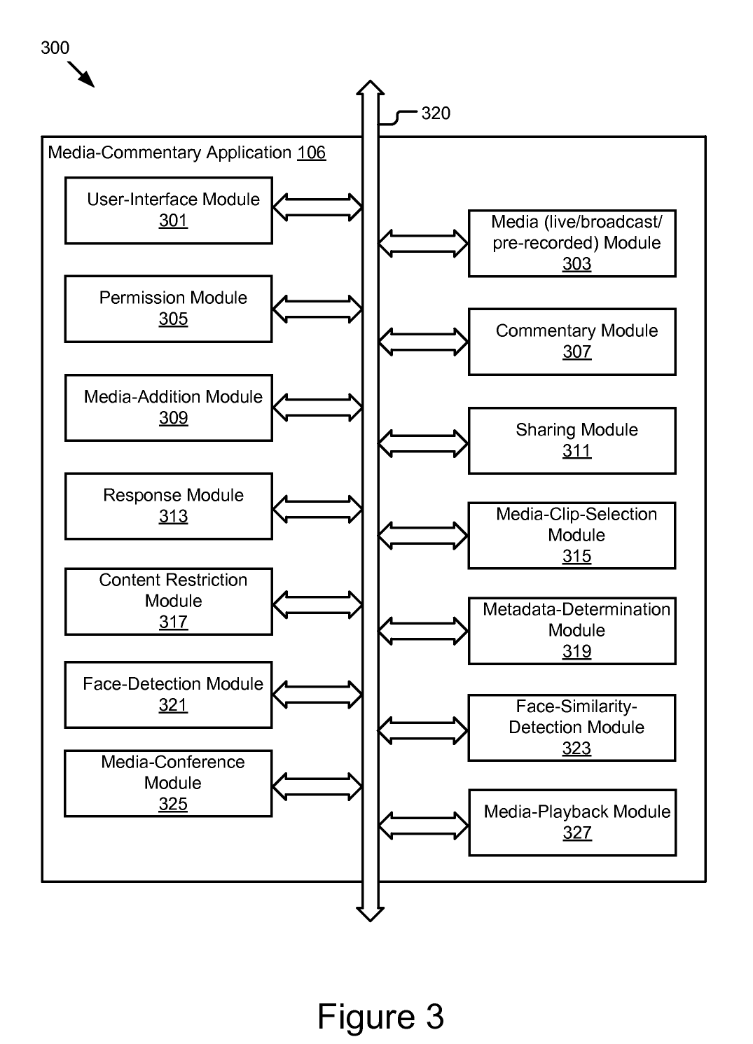

Referring now to FIG. 3, like reference numerals have been used to reference like components with the same or similar functionality that has been described above with reference to FIGS. 1 and 2. Since those components have been described above that description is not repeated here. An implementation of the media-commentary application 106, indicated in FIG. 3 by reference numeral 300, includes various applications or engines that are programmed to perform the functionalities described here. A user-interface module 301 may be coupled to a bus 320 to communicate with one or more components of the media-commentary application 106. By way of example, a particular user 125a communicates via a user device 115a, to display commentary in a user interface. A media module 303 receives or plays media (e.g., live, broadcast, or pre-recorded) web media to one or more online communities, for example a social network. A permission module 305 determines permissions for maintaining user privacy. A commentary module 307 attaches commentary to the broadcast media. A media addition module 309 adds the different types of media to the commentary. A sharing module 311 provides the commentary to an online community, for example, a social network. A response module 313 adds responses to existing commentary. A media-clip-selection module 315 selects a media clip from an online media source. A content-restriction module 317 restricts the content available to be selected as a clip. A metadata-determination module 319 determines metadata associated with media. A face-detection module 321 detects facial features from images and/or videos. A face-similarity-detection module 323 determines facial similarities between one or more face recognition results. A media-conference module 325 begins and maintains media conferences between one or more users. A media-playback module 327 plays media clips during a media conference between one or more users.

The media-commentary application 106 includes applications or engines that communicate over the software communication mechanism 320. Software communication mechanism 320 may be an object bus (for example CORBA), direct socket communication (for example TCP/IP sockets) among software modules, remote procedure calls, UDP broadcasts and receipts, HTTP connections, function or procedure calls, etc. Further, the communication could be secure (SSH, HTTPS, etc.). The software communication may be implemented on underlying hardware, for example a network, the Internet, a bus 220 (FIG. 2), a combination thereof, etc.

The user-interface module 301 may be software including routines for generating a user interface. In some implementations, the user-interface module 301 can be a set of instructions executable by the processor 235 to provide the functionality described below for generating a user interface for displaying media commentary. In other implementations, the user-interface module 301 can be stored in the memory 237 of the social network server 102 and/or the third party server 134 and can be accessible and executable by the processor 235. In either implementation, the user-interface module 301 can be adapted for cooperation and communication with the processor 235, the communication unit 241, data storage 239 and other components of the social network server 102 and/or the third party server 134 via the bus 220.

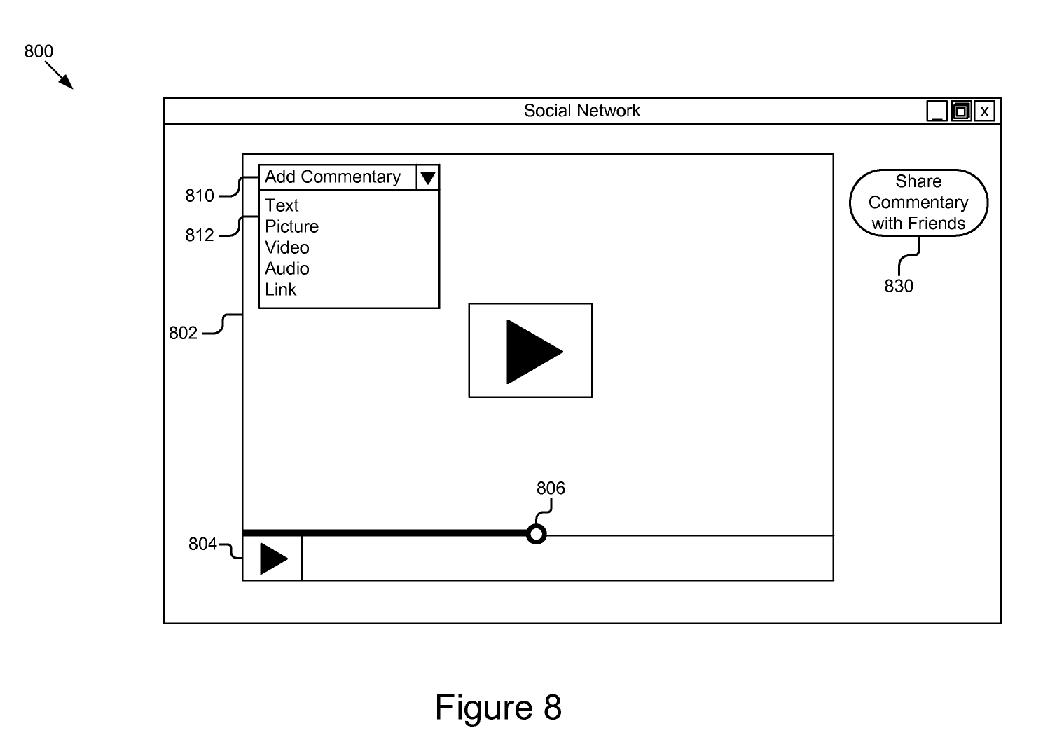

The user-interface module 301 creates a user interface for displaying media commentary on an online community, for example, a social network. In some implementations, the user-interface module 301 receives commentary information and displays the commentary on the web media. In other implementations, the user-interface module 301 displays other information relating to web media and/or commentary. For example, the user-interface module 301 may display a user interface for selecting a particular media clip from the media, for selecting and sharing metadata associated with the media, for setting restrictions to the sharing of the media, for commenting within written media (i.e., text), for providing notifications, for displaying media conference chats, etc. Restrictions may include indicating restrictions on sharing specific portions of the media, restrictions on a length, extent, or duration of the media designated for sharing, restrictions on viewing of a total amount of portions of the media after it is selected for sharing, and restrictions on an amount of media for consumption by a user that is selected for sharing. In addition, the user-interface module may be configured to maintain a record of a user consumption history and receive ratings from users on commentary and enable viewing of the rating by other users. The user-interface will be described in more detail with reference to FIGS. 8-18.

The media module 303 may be software including routines for either receiving live media, media that is broadcast, or pre-recorded media. In some implementations, the media module 303 can be a set of instructions executable by the processor 235 to provide the functionality described below for either receiving live media, media that is broadcast or pre-recorded media that is provided online within a social network. In other implementations, the media module 303 can be stored in the memory 237 of the social network server 102 and/or the third party server 134 and can be accessible and executable by the processor 235. In either implementation, the media module 303 can be adapted for cooperation and communication with the processor 235, the communication unit 241, data storage 239 and other components of the social network server 102 and/or the third party server 134 via the bus 220.

The media module 303 receives either live media, media that is broadcast or pre-recorded media for viewing by one or more users of an online community, for example, a social network. In some implementations, the media module 303 hosts media via an online service. For example, the media module 303 may receive for viewing one or more videos, audio clips, text, etc., by the users of a social network or other integrated networks. As another example, the media module 303 may broadcast media to users of a social network or other integrated networks. As yet another example, the media module 303 may provide pre-recorded media for viewing by users of a social network or other integrated networks.

The permission module 305 may be software including routines for determining user permissions. In some implementations, the permission module 305 can be a set of instructions executable by the processor 235 to provide the functionality described below for determining user permissions to maintain user privacy. In other implementations, the permission module 305 can be stored in the memory 237 of the social network server 102 and/or the third party server 134 and can be accessible and executable by the processor 235. In either implementation, the permission module 305 can be adapted for cooperation and communication with the processor 235, the communication unit 241, data storage 239 and other components of the social-network server 102 and/or the third-party server 134 via the bus 220.

The permission module 305 determines visibility levels of various types of content while maintaining each user's privacy. In some implementations, the permission module 305 determines the visibility of media hosted by the broadcast module 303. For example, the permission module 305 determines permissions for viewing media by determining user information. In other implementations, the permission module 305 determines permissions for viewing commentary. For example, one or more users (e.g., a group in a social network) may have permission (e.g., given by the commentary creator) to view commentary created by a particular user. For another example, the permission to view commentary may be based on one or more age of the user, social relationship to the user, content of the commentary, number of shares, popularity of the commentary, etc.

The commentary module 307 may be software including routines for generating commentary. In some implementations, the commentary module 307 can be a set of instructions executable by the processor 235 to provide the functionality described below for generating one or more types of media commentary. In other implementations, the commentary module 307 can be stored in the memory 237 of the social network server 102 and/or the third party server 134 and can be accessible and executable by the processor 235. In either implementation, the commentary module 307 can be adapted for cooperation and communication with the processor 235, the communication unit 241, data storage 239 and other components of the social network server 102 and/or the third party server 134 via the bus 220.

The commentary module 307 creates and adds different types of media commentary to be attached to broadcast media. In some implementations, the commentary module 307 specifies a period of time to display commentary, receives media from the media addition module 309, attaches the media to the commentary, and saves the commentary for viewing by other users of the online community.

In some implementations, commentary module 307 enables commenting within content for written media (e.g., books, magazines, newspapers). These comments may be associated with specific words, phrases, sentences, paragraphs, or longer blocks of text. The comments may also be associated with photographs, drawings, figures, or other pictures in the document. The comments may be made visible to other users when the content is viewed. Comments may be shared among users connected by a social network. Comments may be displayed to users via a social network, or in some cases users may be directly notified of comments via email, instant messaging, or some other active notifications mechanism. In some implementations, commentators may have explicit control over who sees their comments. Users may also have explicit control to selectively view or hide comments or commentators that are available to them.

In some implementations, users may comment on other users' comments and therefore start an online conversation. Online “conversations” may take many interesting forms. For example, readers may directly comment on articles in newspapers and magazines. A teacher/scholar/expert/critic may provide interpretations, explanations, examples, etc. about various items in a document. In some implementations, an “annotated” version of a document may be offered for purchase differently than the source document. For example book clubs, a class of students, and other formal groups may discuss a specific book. Co-authors may use this mechanism as a means of collaboration. This mechanism may encourage serendipitous conversations among users across the social network and other online communities.

In some implementations, a comment may be shared along with a clip (i.e., a portion) of the source document and perhaps knowledge or metadata associated with the document. Also, commentary in written documents may be used beyond written commentary. For example, users may attach photos to specific points in the text (e.g., a photo of Central Park attached to a written description of the park). In general, commentary may be other sorts of pictures, video, audio, URLs, etc.

In some implementations, users' comments may include links (e.g., URLs) to other conversations or to other play-points in the media or in other media sources.

In some implementations, users may reference other user comments or arbitrary play-points. For example, a user may start a comment by asking for an explanation of a conversation between two characters in a movie. Another user may respond with a comment that includes a link to an earlier play point which provides the context for understanding this conversation. Similarly, if this question had already been answered by existing users' comments, someone may want to respond with a link to this existing comment thread. It would also be useful to be able to link into existing comments, via a URL or some other form of link that may be included in an email, chat, or social network stream.

The media-addition module 309 may be software including routines for adding media to commentary. In some implementations, the media-addition module 309 can be a set of instructions executable by the processor 235 to provide the functionality described below for adding one or more media elements to media commentary. In other implementations, the media-addition module 309 can be stored in the memory 237 of the social network server 102 and/or the third-party server 134 and can be accessible and executable by the processor 235. In either implementation, the media-addition module 309 can be adapted for cooperation and communication with the processor 235, the communication unit 241, data storage 239 and other components of the social network server 102 and/or the third party server 134 via the bus 220.

The media-addition module 309 adds one or more media elements to media commentary. In some implementations, the media-addition module 309 receives one or more media objects (e.g., video, audio, text, etc.) from one or more users, and adds the one or more received media objects to the commentary from the commentary module 307.

The sharing module 311 may be software including routines for sharing commentary. In some implementations, the sharing module 311 can be a set of instructions executable by the processor 235 to provide the functionality described below for sharing media commentary within a social network. In other implementations, the sharing module 311 can be stored in the memory 237 of the social network server 102 and/or the third party server 134 and can be accessible and executable by the processor 235. In either implementation, the sharing module 311 can be adapted for cooperation and communication with the processor 235, the communication unit 241, data storage 239 and other components of the social-network server 102 and/or the third-party server 134 via the bus 220.

The sharing module 311 shares the media commentary to one or more users of an online community, for example, a social network. In some implementations, the sharing module 311 sends notifications to one or more users of the online community. For example, the sharing module 311 sends a notification to one or more users via one or more email, instant messaging, social network post, blog post, etc. In some implementations, the notification includes a link to the media containing the commentary. In some implementations, the notification includes a link to the video containing the commentary and a summary of the media and/or commentary. In other implementations, the notification includes the media clip and commentary.

The response module 313 may be software including routines for responding to media commentary. In some implementations, the response module 313 can be a set of instructions executable by the processor 235 to provide the functionality described below for responding to media commentary with one or more additional media elements within a social network. In other implementations, the response module 313 can be stored in the memory 237 of the social network server 102 and/or the third party server 134 and can be accessible and executable by the processor 235. In either implementation, the response module 313 can be adapted for cooperation and communication with the processor 235, the communication unit 241, data storage 239 and other components of the social network server 102 and/or the third party server 134 via the bus 220.

The response module 313 responds to users' commentary. This implementation creates an interface for users to converse between each other using different types of commentary. In some implementations, the response module 313 receives one or more commentaries from one or more users in response to the first commentary. For example, a first user posts commentary on a video stating the type of car that is in the scene. Then another user posts a response commentary revealing that the first user is wrong and the car is actually a different type.

The media-clip-selection module 315 may be software including routines for selecting media clips. In some implementations, the media-clip-selection module 315 can be a set of instructions executable by the processor 235 to provide the functionality described below for selecting a media clip from an online media source. In other implementations, the media-clip-selection module 315 can be stored in the memory 237 of the social-network server 102 and/or the third-party server 134 and can be accessible and executable by the processor 235. In either implementation, the media-clip-selection module 315 can be adapted for cooperation and communication with the processor 235, the communication unit 241, data storage 239 and other components of the social-network server 102 and/or the third-party server 134 via the bus 220.

In some implementations, the media-clip-selection module 315 selects one or more media clips and shares (e.g., via the sharing module 311) the clip (of their choice) with friends to start a conversation. For example, a user may select a beginning point and a stopping point of the media and save it within the user's social profile.

In some implementations, users may comment within content (e.g., a scene in a movie, a paragraph in a book, etc.). Other users may then see the comments as they consume the content along with a clip of the relevant content (e.g., a thumbnail of the movie scene, a clip of the movie, clip of audio, etc.).

The content-restriction module 317 may be software including routines for restricting content. In some implementations, the content-restriction module 317 can be a set of instructions executable by the processor 235 to provide the functionality described below for restricting the content available to be selected as a clip. In other implementations, the content-restriction module 317 can be stored in the memory 237 of the social-network server 102 and/or the third-party server 134 and can be accessible and executable by the processor 235. In either implementation, the content-restriction module 317 can be adapted for cooperation and communication with the processor 235, the communication unit 241, data storage 239 and other components of the social network server 102 and/or the third party server 134 via the bus 220.

In some implementations, the content-restriction module 317 restricts the content (e.g., media clips) that is shared between users. The content-restriction module 317 indicates restrictions on sharing specific scenes (e.g., the climax in a movie) and other restrictions (e.g., max length of clip, etc.). In some instances, the content-restriction module 317 restricts the number of previews a user may view of a specific piece of media by maintaining record of the user's preview consumption history.

In some implementations, the content-restriction module 317 restricts users from sharing arbitrary parts of media. In some implementations, the content-restriction module 317 restricts users from sharing any part of a particular portion of media. In some instances, the content-restriction module 317 receives a maximum amount of content that a given user can consume via ‘clips’ from the content owner (e.g., the content creator). For example, if there are hundreds of clips available in the system, a user may only consume as many clips as will be allowed (by the owner) to keep their consumption under the owner specified limit.

In some embodiments, the content-restriction module 317 receives information from the owners of the media to block certain parts of their media from ever being shared. This will allow them to block the climax of a movie and/or book, such that it does not spoil the experience for potential customers.

The metadata-determination module 319 may be software including routines for determining metadata. In some implementations, the metadata-determination module 319 can be a set of instructions executable by the processor 235 to provide the functionality described below for determining metadata associated with media. In other implementations, the metadata-determination module 319 can be stored in the memory 237 of the social-network server 102 and/or the third-party server 134 and can be accessible and executable by the processor 235. In either implementation, the metadata-determination module 319 can be adapted for cooperation and communication with the processor 235, the communication unit 241, data storage 239 and other components of the social-network server 102 and/or the third-party server 134 via the bus 220.

In some implementations, the metadata-determination module 319 determines metadata (e.g., knowledge) associated with a media clip. The metadata-determination module 319 provides a knowledge layer on top of each clip. In some instances, metadata has already been added to media within some online services. In some implementations, the metadata-determination module 319 adds a knowledge layer to clips that are shared to help begin a conversation. For example, metadata may provide interesting information about the media (e.g., the actor's line in this movie was completely spontaneous).

The face-detection module 321 may be software including routines for facial feature detection. In some implementations, the face-detection module 321 can be a set of instructions executable by the processor 235 to provide the functionality described below for detecting facial features from images and/or videos. In other implementations, the face-detection module 321 can be stored in the memory 237 of the social-network server 102 and/or the third-party server 134 and can be accessible and executable by the processor 235. In either implementation, the face-detection module 321 can be adapted for cooperation and communication with the processor 235, the communication unit 241, data storage 239 and other components of the social network server 102 and/or the third-party server 134 via the bus 220.

In some embodiments, the face-detection module 321 receives one or more images and/or videos and performs face recognition on the one or more images and/or videos. For example, the face-detection module 321 may detect a user's face and determine facial features (e.g., skin color, size of nose, size of ears, hair color, facial hair, eyebrows, lip color, chin shape, etc.).

In some implementations, the face detection module 321 may detect whether a three-dimensional object within a two-dimensional photograph exists. For example, the face-detection module 321 may use multiple graphical probability models to determine whether a three-dimensional object (e.g., a face) appears in the two-dimensional image and/or video.

The face-similarity-detection module 323 may be software including routines for detecting facial similarities. In some implementations, the face-similarity-detection module 323 can be a set of instructions executable by the processor 235 to provide the functionality described below for determining facial similarities between one or more face recognition results. In other implementations, the face-similarity-detection module 323 can be stored in the memory 237 of the social-network server 102 and/or the third-party server 134 and can be accessible and executable by the processor 235. In either implementation, the face-similarity-detection module 323 can be adapted for cooperation and communication with the processor 235, the communication unit 241, data storage 239 and other components of the social network server 102 and/or the third-party server 134 via the bus 220.

In some implementations, the face-similarity-detection module 323 receives facial recognition information from the face-detection-module 321 and determines whether one or more faces are similar. For example, a user may compare actors in a movie with friends in a social network. In some implementations, the face-similarity-detection module 323 may suggest avatars (e.g., profile pictures) based on screenshots from movies. The comparison may be initiated manually (by a user) or automatically (by the social network) and may be used when sharing photos within social networks.

The media-conference module 325 may be software including routines for maintaining a media conference. In some implementations, the media-conference module 325 can be a set of instructions executable by the processor 235 to provide the functionality described below for beginning and maintaining media conferences between one or more users. In other implementations, the media conference module 325 can be stored in the memory 237 of the social-network server 102 and/or the third-party server 134 and can be accessible and executable by the processor 235. In either implementation, the media-conference module 325 can be adapted for cooperation and communication with the processor 235, the communication unit 241, data storage 239 and other components of the social-network server 102 and/or the third-party server 134 via the bus 220.

In some implementations, the media conference module 325 initiates and maintains the functionality of a media conference. For example, the media conference may be a video chat, an audio chat, a text-based chat, etc. In some instances, the media-conference module 325 receives one or more users and establishes a media connection that allows the one or more users to communicate over a network.

The media-playback module 327 may be software including routines for playing media clips. In some implementations, the media-playback module 327 can be a set of instructions executable by the processor 235 to provide the functionality described below for playing media clips during a media conference between one or more users. In other implementations, the media-playback module 327 can be stored in the memory 237 of the social-network server 102 and/or the third-party server 134 and can be accessible and executable by the processor 235. In either implementation, the media-playback module 327 can be adapted for cooperation and communication with the processor 235, the communication unit 241, data storage 239 and other components of the social-network server 102 and/or the third-party server 134 via the bus 220.

In some implementations, the media-playback module 327 plays a media clip during a media conference. For example, the media-playback module 327 receives a video scene from a user (e.g., the user's favorite scene and/or quote) from a movie. In some instances, a user may select one or more clips from the user interface of the media player and the media-playback module 327 may play the selected clip during the media conference. For example, a video clip may be played during a video conference.

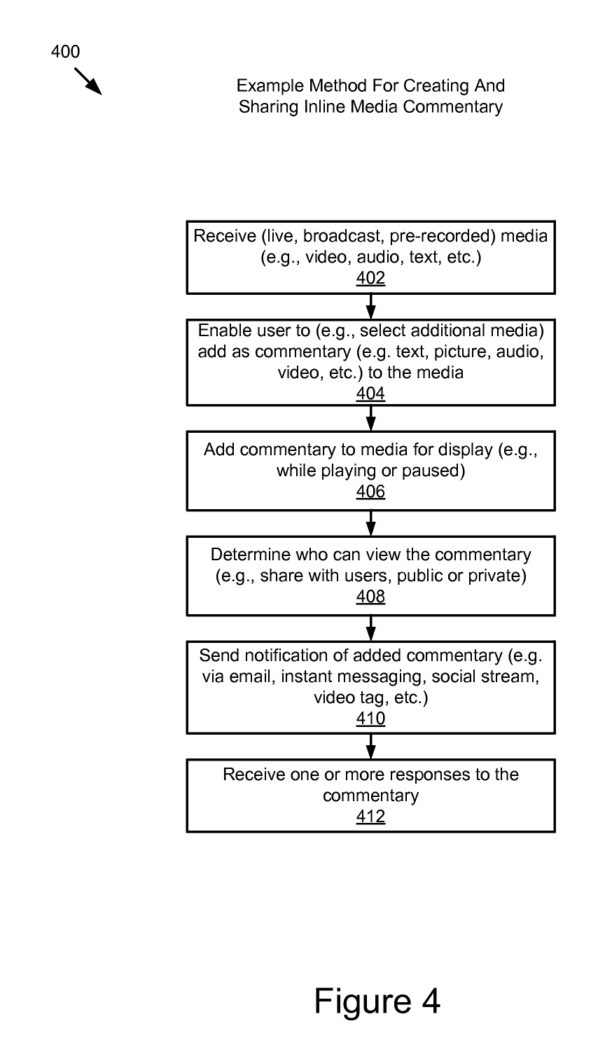

FIG. 4 is a flow chart illustrating an example method indicated by reference numeral 400 for creating and sharing inline media commentary. It should be understood that the order of the operations in FIG. 4 is merely by way of example and may be performed in different orders than those that are illustrated and some operations may be excluded, and different combinations of the operations may be performed. In the example method illustrated, one or more operations may include receiving live or pre-recorded media or broadcasting media (e.g., video, audio, text, etc.), as illustrated by block 402. The method 400 then proceeds to the next block 404 and may include one or more operations to enable a user to add commentary (e.g., by selecting additional media to add as commentary (e.g., text, picture, audio, video, etc.)) to the media. The method 400 then proceeds to the next block 406 and may include one or more operations to add additional media to received or broadcast media for display (e.g., while playing or paused). The method 400 then proceeds to the next block 408 and may include one or more operations to determine who can view the commentary (e.g., public or private). The method 400 then proceeds to the next block 410 and may include one or more operations to send a notification of added commentary (e.g., via email, instant messaging, social stream, video tag, etc.). The method 400 then proceeds to the next block 412 and may include one or more operations to receive one or more responses to the commentary.

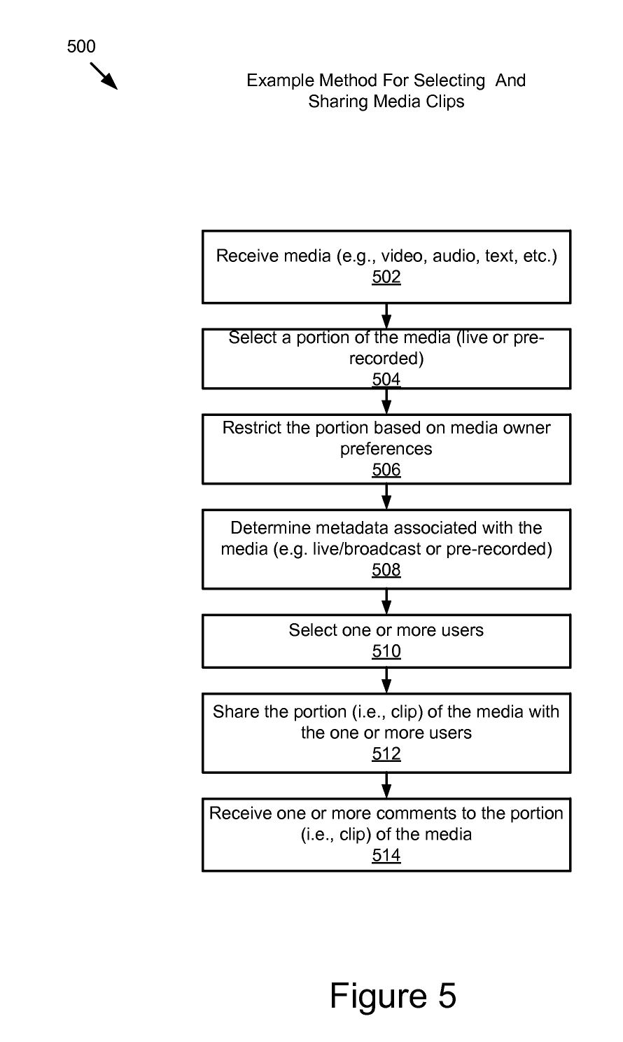

FIG. 5 is a flow chart illustrating an example method indicated by reference numeral 500 for selecting and sharing media clips. It should be understood that the order of the operations in FIG. 5 is merely by way of example and may be performed in different orders than those that are illustrated and some operations may be excluded, and different combinations of the operations may be performed. In the example method illustrated, one or more operations may include receiving, broadcasting, or viewing media (e.g., video, audio, text, etc.), as illustrated by block 502. The method 500 then proceeds to the next block 504 and may include one or more operations to select a portion of the media (live or pre-recorded media received or broadcast). The method 500 then proceeds to the next block 506 and may include one or more operations to restrict the portion based on the media (e.g., received, broadcast, or viewed) owner preferences. The method 500 then proceeds to the next block 508 and may include one or more operations to determine metadata associated with the media. The method 500 then proceeds to the next block 510 and may include one or more operations to select one or more users. The method 500 then proceeds to the next block 512 and may include one or more operations to share the portion (i.e., clip) of the media with the one or more users. The method 500 then proceeds to the next block 514 and may include one or more operations to receive one or more comments to the portion (i.e., clip) of the media.

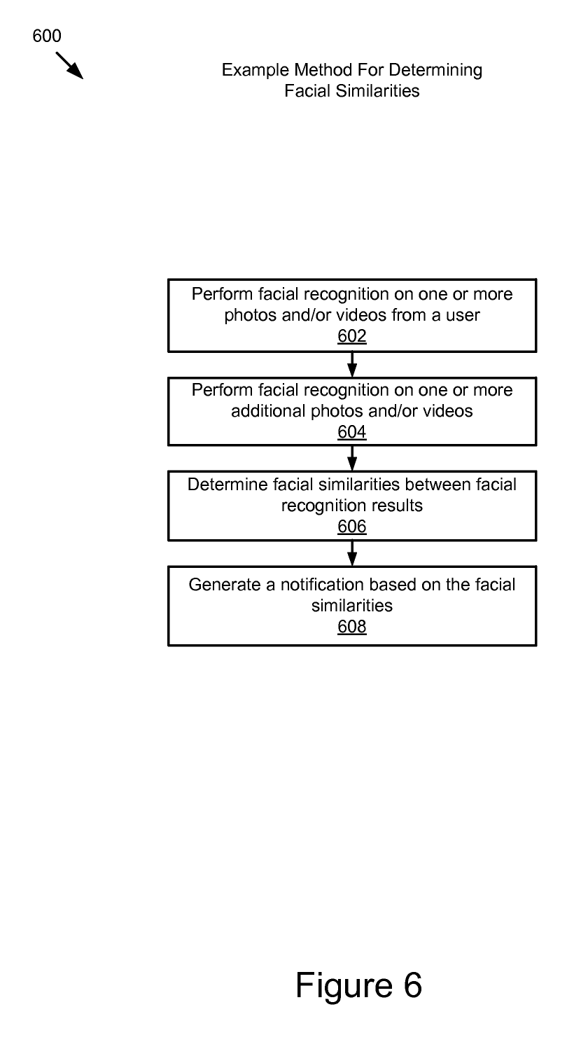

FIG. 6 is a flow chart illustrating an example method indicated by reference numeral 600 for determining facial similarities. It should be understood that the order of the operations in FIG. 6 is merely by way of example and may be performed in different orders than those that are illustrated and some operations may be excluded, and different combinations of the operations may be performed. In the example method illustrated, one or more operations may include performing facial recognition on one or more photos and/or videos from a user, as illustrated by block 602. The method 600 then proceeds to the next block 604 and may include one or more operations to performing facial recognition on one or more additional photos and/or videos. The method 600 then proceeds to the next block 606 and may include one or more operations to determine facial similarities between the facial recognition results. The method 600 then proceeds to the next block 608 and may include one or more operations to generate a notification based on the facial similarities.

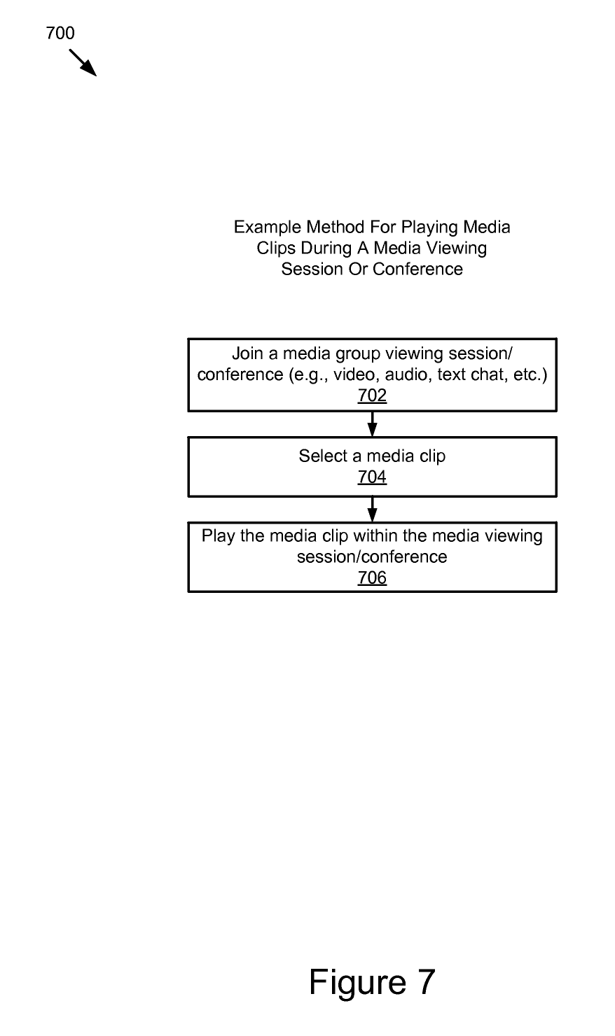

FIG. 7 is a flow chart illustrating an example method indicated by reference numeral 700 for playing media clips during a media conference. It should be understood that the order of the operations in FIG. 7 is merely by way of example and may be performed in different orders than those that are illustrated and some operations may be excluded, and different combinations of the operations may be performed. In the example method illustrated, one or more operations may include joining a media viewing session or conference (e.g., video, audio, text chat, etc.), as illustrated by block 702. The method 700 then proceeds to the next block 704 and may include one or more operations to select a media clip. The method 700 then proceeds to the next block 706 and may include one or more operations to play the media clip within the media viewing session or conference.

FIG. 8 illustrates one example of a user interface 800 for adding media as commentary to a web video 802 using an interface within the web video 802. In this example, the user interface includes the web video 802, a “play” button, icon, or visual display 804, a point of play 806, a commentary selection box 810, a commentary media list 812, and a commentary sharing button or visual display 830. The web video 802 may be a video uploaded by one or more users of an online community. The “play” button, icon, or visual display 804 starts and stops the web video 802. The point of play 806 illustrates the progression of the video from beginning to end. The commentary selection box 810 contains a commentary media list 812 for selecting the type of media to be inserted into the web video 802 at the particular point of play 806. The commentary sharing button or visual display 830 initiates sharing the added commentary to one or more users of the online community, for example, a social network. In these examples, a web video is used by way of example and not by limitation. The broadcast media may also be audio, text, etc. For simplicity and ease of understanding, a video example is used here.

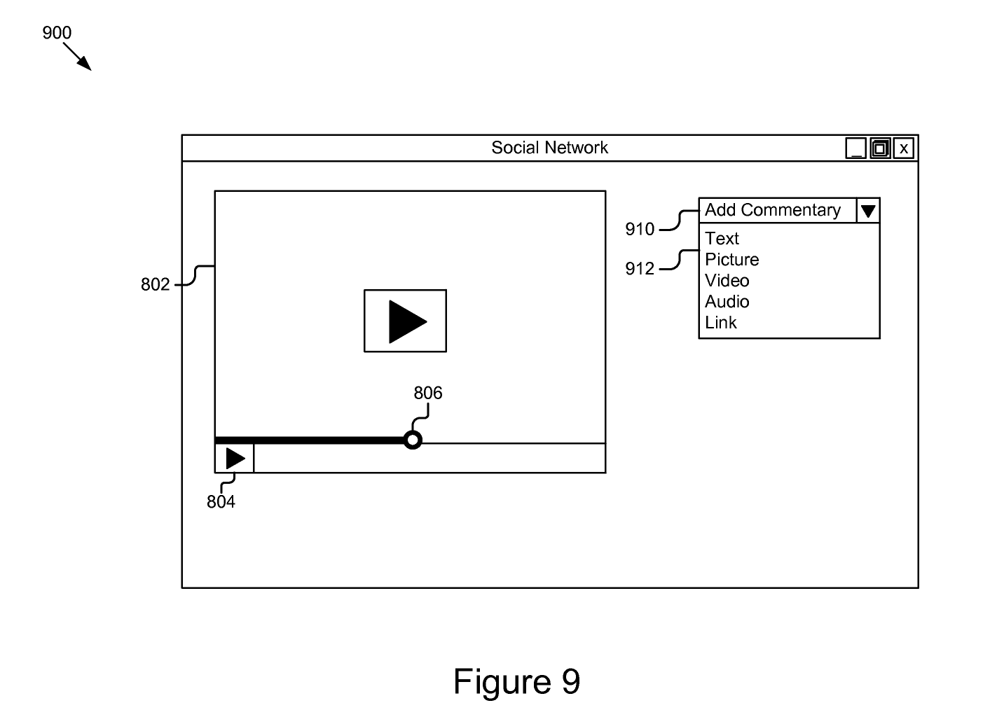

FIG. 9 illustrates one example of a user interface 900 for adding media as commentary to the web video 802 using an interface external to the web video 802. In this example, the user interface includes the web video 802, the “play” button or visual display 804, the point of play 806, a commentary selection box 910, and a commentary media list 912. In the present example, the commentary selection box 910 and the commentary media list 912 may be external to the web video 802.

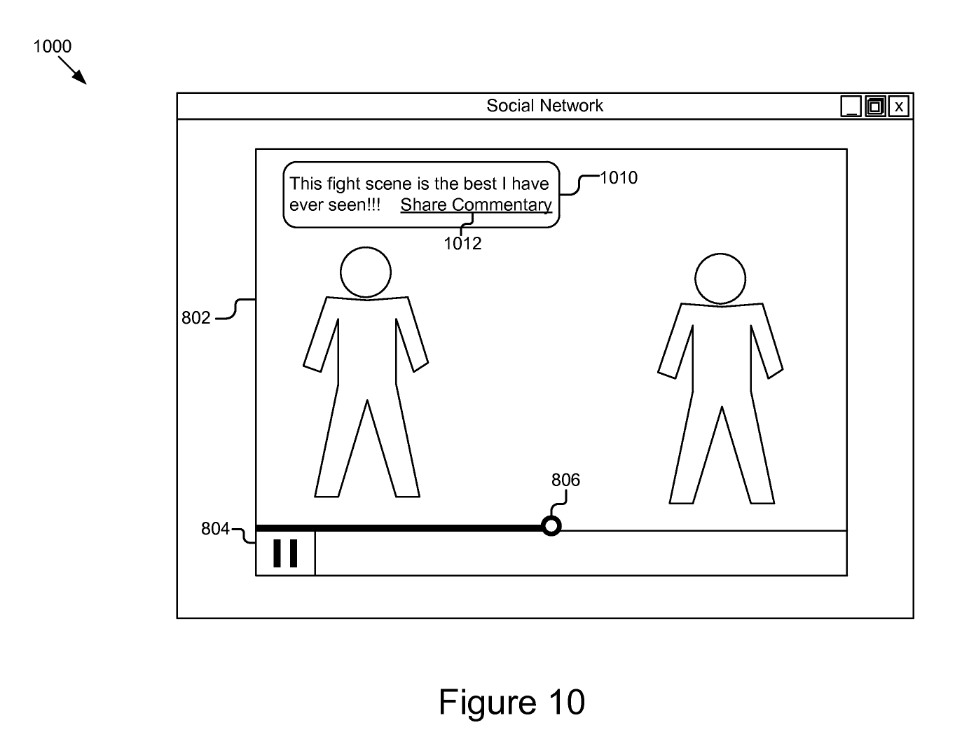

FIG. 10 illustrates one example of a user interface 1000 for displaying text based video commentary. In this example, the user interface includes the web video 802, the “play” button or visual display 804, the point of play 806, a text commentary 1010, and a sharing link 1012. The text commentary 1010 appears either while the video is paused (or on pause) or while the video is playing. If the text commentary 1010 is displayed while the web video 802 is playing, then the text commentary 1010 may be displayed for a predetermined amount of time (i.e., a number of frames). The text commentary 1010 contains a sharing link 1012 for triggering an interface for sharing the commentary with users of an online community, for example, a social network.

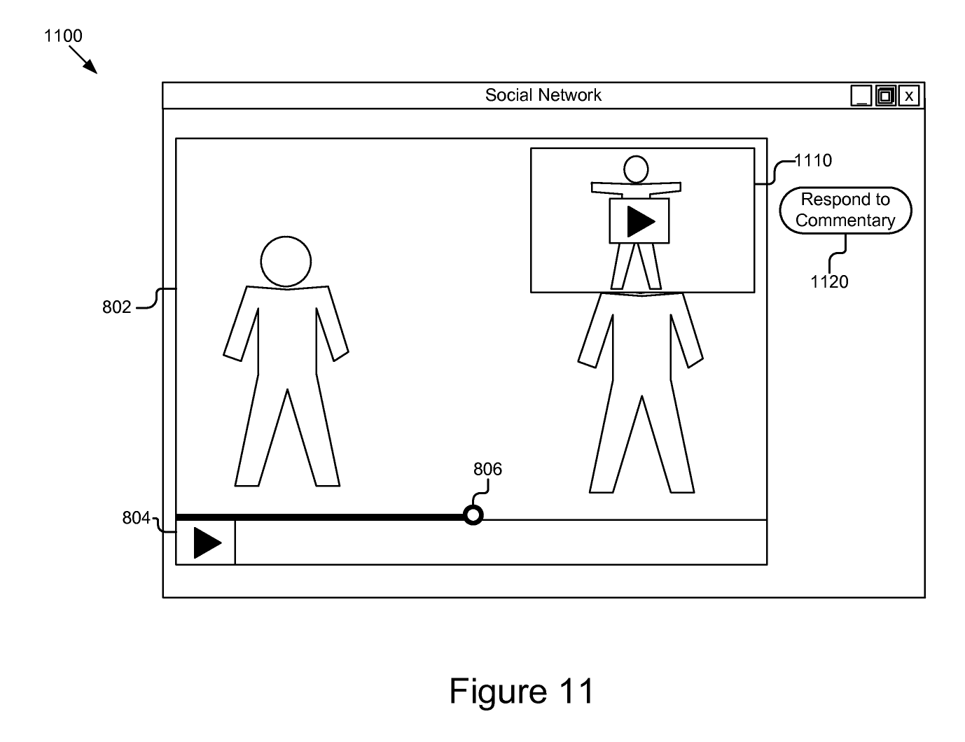

FIG. 11 illustrates one example of a user interface 1100 for displaying video based video commentary. In this example, the user interface includes the web video 802, the “play” button 804, the point of play 806, a video commentary 1110, and a response button or visual display 1120. The video commentary 1110 appears when the video reaches a certain play point 806, and may be played for a predetermined amount of time (i.e., a number of frames). The response button or visual display 1120 initiates a user interface for a user to respond to existing commentary of the video. In addition to the response or as part of the response, a user may provide a rating for the commentary.

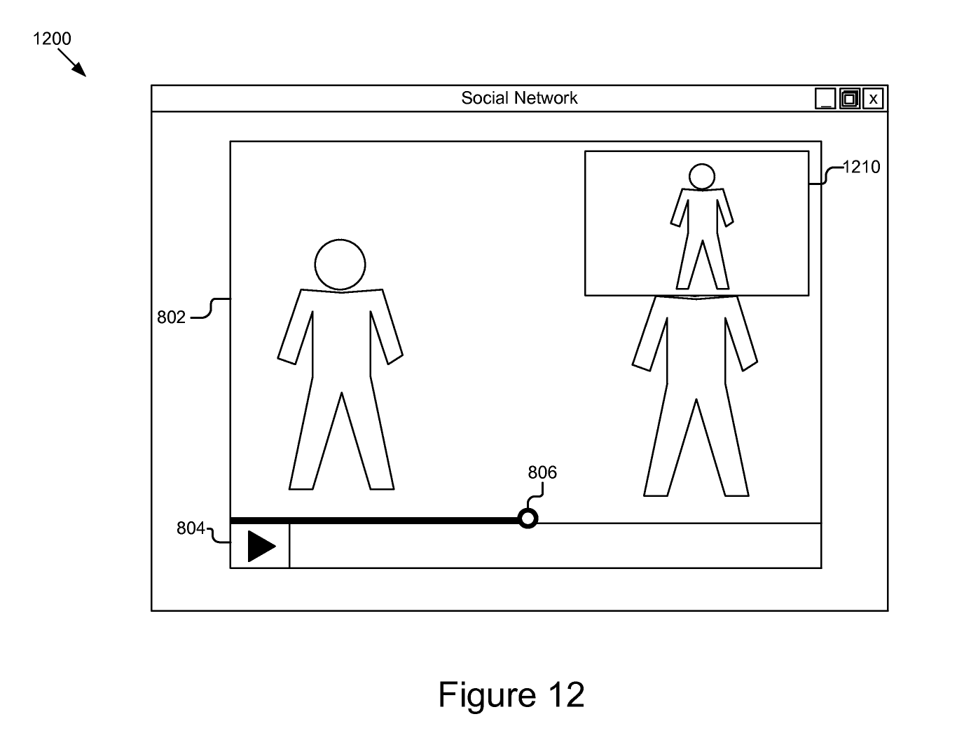

FIG. 12 illustrates one example of a user interface 1200 for displaying an image-based video commentary. In this example, the user interface includes the web video 802, the “play” button 804, the point of play 806, and an image commentary 1210. The image commentary 1210 appears when the video reaches a certain point of play 806, and may be played for a predetermined amount of time (i.e., a number of frames).

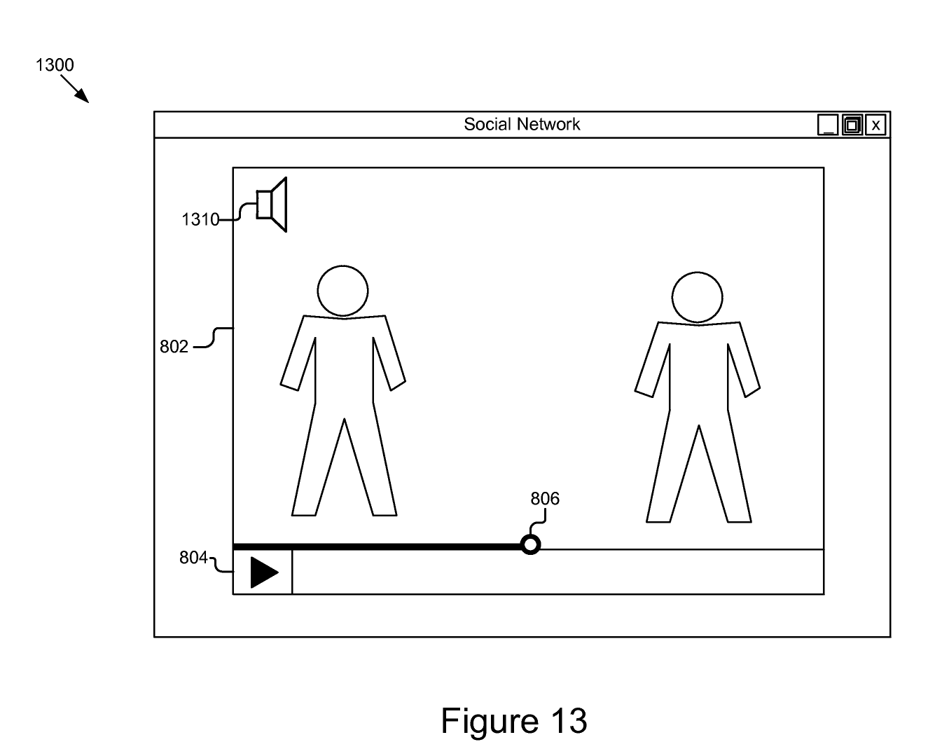

FIG. 13 illustrates one example of a user interface 1300 for playing audio based video commentary. In this example, the user interface includes the web video 802, the “play” button or visual display 804, the point of play 806, and an audio commentary 1310. The audio commentary 1310 may be played when the video reaches a certain point of play 806, and may be played for a predetermined amount of time (i.e., a number of frames). In some implementations, a graphic may be displayed signifying that an audio commentary 1310 is playing. In other implementations, no graphic may be displayed when the audio commentary 1310 is playing.

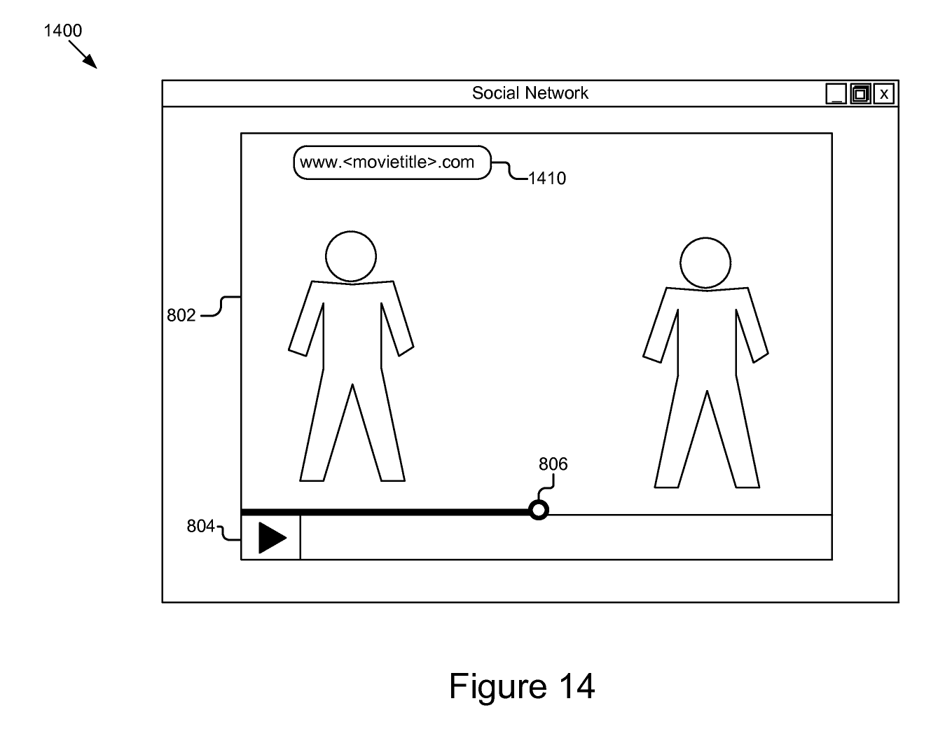

FIG. 14 illustrates one example of a user interface 1400 for displaying URL link-based video commentary. In this example, the user interface includes the web video 802, the “play” button or visual display 804, the point of play 806, and a URL link commentary 1410. The URL link commentary 1410 appears either while the video is paused or while the video is playing. If the text commentary 1010 is displayed while the web video 802 is playing, the URL link commentary 1410 may be displayed for a predetermined amount of time (i.e., a number of frames).

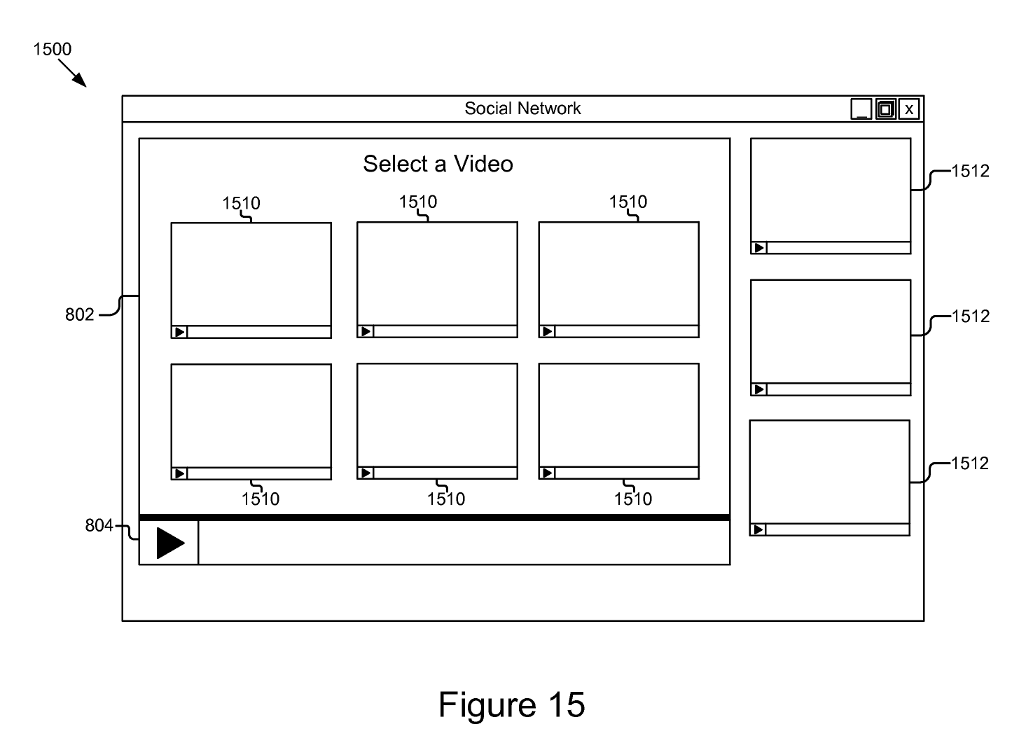

FIG. 15 illustrates one example of a user interface 1500 for displaying one or more videos either within or external to the web video 802. In this example, the user interface includes the web video 802, the “play” button or visual display 804, web videos 1510 that are displayed within the web video 802, and web videos 1512 that are displayed external to the web video 802.

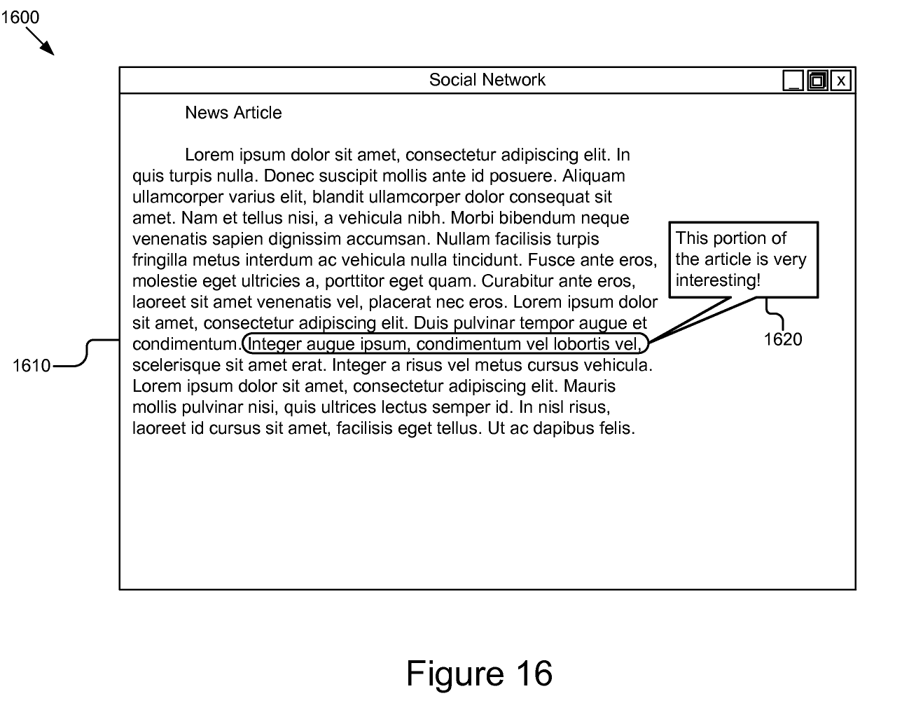

FIG. 16 illustrates one example of a user interface 1600 for displaying a comment within written media (e.g., a news article). In this example, the user interface includes the news article 1610, and the comment 1620. For example, a user may read a news article and leave a comment that other user's within a social network may want to read.

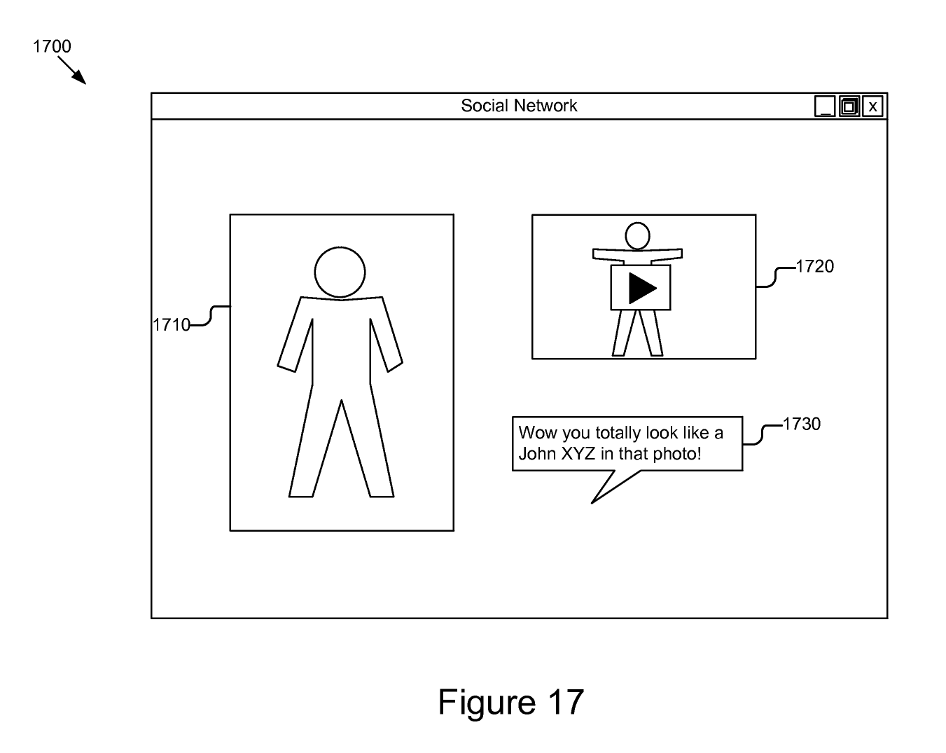

FIG. 17 illustrates one example of a user interface 1700 for notifying a user of facial similarities. In this example, the user interface includes the user image 1710, the video clip 1720, and the comment 1730. For example, the user posts a picture of his self and is notified via the comment 1730 that he looks like John XYZ (e.g., an actor in the video) in the user image 1710.

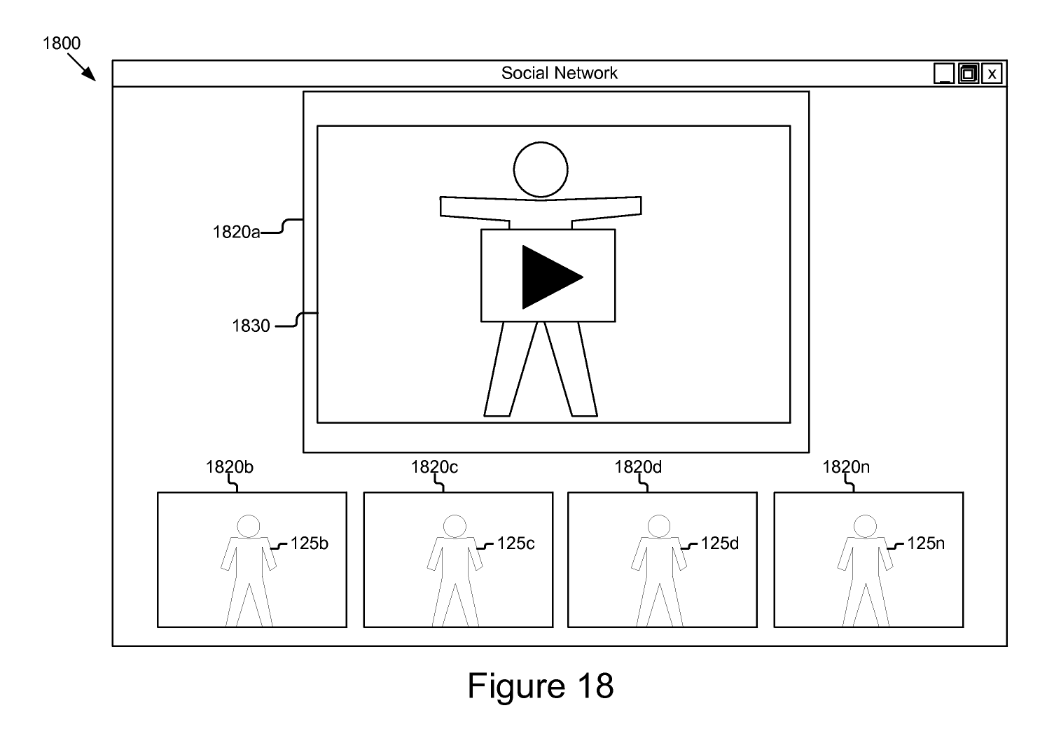

FIG. 18 illustrates one example of a user interface 1800 for displaying a video clip during a video conference. In this example, the user interface includes the user video streams 1820a through 1820n, and a video clip 1830. For example, a user may decide to select and display a video clip 1830 in the user video stream 1820a, and thus displaying the clip to the users 125b through 125n.

In the preceding description, for purposes of explanation, numerous specific details are indicated in order to provide a thorough understanding of the technology described. This technology may be practiced without these specific details. In the instances illustrated, structures and devices are shown in block diagram form in order to avoid obscuring the technology. For example, the present technology is described with some implementations illustrated above with reference to user interfaces and particular hardware. However, the present technology applies to a computing device that can receive data and commands, and devices providing services. Moreover, the present technology is described above primarily in the context of creating and sharing inline video commentary within a social network; however, the present technology applies to a situation and may be used for other applications beyond social networks. In particular, this technology may be used in other contexts besides social networks.

Reference in the specification to “one implementation,” “an implementation,” or “some implementations” means simply that one or more particular features, structures, or characteristics described in connection with the one or more implementations is included in at least one or more implementations that are described. The appearances of the phrase “in one implementation or instance” in various places in the specification are not necessarily referring to the same implementation or instance.

Some portions of the detailed descriptions above are presented in terms of algorithms and symbolic representations of operations on data bits within a computer memory of either one or more computing devices. These algorithmic descriptions and representations are the means used to most effectively convey the substance of the technology. An algorithm as indicated here, and generally, may be conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that these and similar terms are to be associated with the appropriate physical quantities and are merely convenient labels applied to these quantities. Unless specifically stated otherwise, as apparent from the preceding discussion, it should be appreciated that throughout the description, discussions utilizing terms, for example, “processing,” “computing,” “calculating,” “determining,” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present technology also relates to an apparatus for performing the operations described here. This apparatus may be specially constructed for the required purposes, or it may include a general-purpose computer selectively activated or reconfigured by a computer program stored in the computer. For example, a computer program may be stored in a computer-readable storage medium, for example, but not limited to, a disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or a type of media suitable for storing electronic instructions, each coupled to a computer system bus.

This technology may take the form of an entirely hardware implementation, an entirely software implementation, or an implementation including both hardware and software components. In some instances, this technology may be implemented in software, which includes but may be not limited to firmware, resident software, microcode, etc.

Furthermore, this technology may take the form of a computer program product accessible from a computer-usable or computer-readable medium providing program code for use by or in connection with a computer or an instruction execution system. For the purposes of this description, a computer-usable or computer-readable medium may be an apparatus that can include, store, communicate, propagate, or transport the program for use by or in connection with the instruction execution system, apparatus, or device.

A data processing system suitable for storing and/or executing program code includes at least one processor coupled directly or indirectly to memory elements through a system bus. The memory elements may include local memory employed during actual execution of the program code, bulk storage, and cache memories, which provide temporary storage of at least some program code in order to reduce the number of times code may be retrieved from bulk storage during execution.

Input/output or I/O devices (including but not limited to keyboards, displays, pointing devices, etc.) may be coupled to the system either directly or through intervening I/O controllers.

Communication units including network adapters may also be coupled to the systems to enable them to couple to other data processing systems, remote printers, or storage devices, through either intervening private or public networks. Modems, cable modems, and Ethernet cards are just a few examples of the currently available types of network adapters.

Finally, the algorithms and displays presented in this application are not inherently related to a particular computer or other apparatus. Various general-purpose systems may be used with programs in accordance with the teachings here, or it may prove convenient to construct more specialized apparatus to perform the required method steps. The required structure for a variety of these systems is outlined in the description above. In addition, the present technology is not described with reference to a particular programming language. It should be understood that a variety of programming languages may be used to implement the technology as described here.

The foregoing description of the implementations of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. The present technology may be implemented in other specific forms, without departing from the spirit or essential characteristics thereof. Likewise, the particular naming and division of the modules, routines, features, attributes, methodologies, and other aspects are not mandatory or significant, and the mechanisms that implement the present disclosure or its features may have different names, divisions and/or formats. Furthermore, the modules, routines, features, attributes, methodologies and other aspects of the present technology can be implemented as software, hardware, firmware, or a combination of the three. Also, wherever a component, an example of which may be a module, of the present technology may be implemented as software, the component can be implemented as a standalone program, as part of a larger program, as a plurality of separate programs, as a statically or dynamically linked library, as a kernel loadable module, as a device driver, and/or in other ways. Additionally, the present technology is in no way limited to implementation in a specific programming language, or for a specific operating system or environment. Accordingly, the disclosure of the present technology is intended to be illustrative, but not limiting, of the scope of the present disclosure, which is set forth in the following claims.

What is claimed is:

1. A method, comprising:
receiving, using at least one computing device, media for viewing by a plurality of users of a network, wherein the media includes at least one of live media and pre-recorded media;
receiving, using the at least one computing device, commentary added by one or more of the plurality of users to the media, at an appropriate point, wherein the appropriate point includes at least one of a group of 1) a selected play-point within the media, 2) a portion of the media, and 3) an object within the media;
storing, using the at least one computing device, the media and the commentary;
selectively sharing, using the at least one computing device, the commentary with one or more users within the network who are selected by a particular user;
enable viewing, using the computing device, of the commentary added with the one or more users who are selected for sharing;
receiving, using the at least one computing device, a comment on the commentary including at least one of a group of 1) text, 2) a photograph, 3) video, 4) audio, 5) a link to other content, and 6) insertion of text and modification to any visual-based, audio-based, and text-based component of the media; and
processing notifications, using the at least one computing device, to selected users of the network on the commentary, wherein the notifications are provided for display on an electronic device for use by the users.

2. A method, comprising:
receiving, using at least one computing device, media for viewing by a plurality of users of a network wherein the media includes at least one of live media and pre-recorded media;
receiving, using the at least one computing device, commentary added by one or more users to the media at a point, wherein the point includes at least one of a group of 1) a selected play-point within the media, 2) a portion of the media, and 3) an object within the media;
storing, using the at least one computing device, the media and the commentary;
selectively sharing, using the at least one computing device, the commentary with one or more users within the network who are selected by a particular user;
enable viewing, using the computing device, of the commentary by the one or the more users with whom the commentary is shared; and
receiving, using the at least one computing device, at least one comment on the commentary including at least one of a group of 1) text, 2) a photograph, 3) video, 4) audio, 5) a link to other content, and 6) insertion of text and modification to any visual-based, audio-based, and text-based component of the media.

3. The method according to claim 2, further comprising:
processing notifications to select users of the network, on the commentary added to the media, wherein the notifications are processed in at least one of the following ways:
receiving from users of the network when the users post commentary;
sending the notifications when the commentary is added;
providing the notifications for display on a plurality of computing and communication devices; and
providing the notifications via a software mechanism including at least one of a group of email, instant messaging, social network software, software for display on a home screen of a computing or communication device.

4. The method according to claim 2, further comprising:
linking commentary to particular entities specified by metadata within the media, wherein the media is at least one of 1) video, 2) audio, and 3) text, and an entity in the video includes at least one of a group of 1) a specific actor, 2) a subject, 3) an object, 4) a location, 5) audio content, and 6) a scene in the media, and an entity in the audio includes audio content and a scene, and an entity in the text includes a portion of the text.

5. The method according to claim 4, wherein the metadata is created by at least one of manual and automatic operations, and the automatic operations include at least one of 1) face recognition, 2) speech recognition, 3) audio recognition, 4) optical character recognition, 5) computer vision, 6) image processing, 7) video processing, 8) natural language understanding, and 9) machine learning.

6. The method according to claim 2, wherein the media is at least one of video, audio, or text.

7. The method according to claim 2, further comprising:
selecting and sharing portions of the media with the commentary with the one or more users within the network who are selected by a particular user.

8. The method according to claim 7, further comprising at least one of the following:
indicating, using the at least one computing device, restrictions on sharing specific portions of the media;
indicating, using the at least one computing device, restrictions on at least one of a length, extent, and duration of the media designated for sharing;
indicating, using the at least one computing device, restrictions on viewing of a total amount of portions of the media by the one or more users after it is selected for sharing by the particular user.

9. The method according to claim 7, wherein the selecting and sharing further comprises at least one of the following:
maintaining a record of user consumption history on shared media;
restricting an amount of media for free consumption by a user that is selected for sharing by the particular user; and
restricting an amount of media for consumption by a specific user that is selected for sharing by the particular user.

10. The method according to claim 2, further comprising:
enabling viewing of the media by a particular user with other select users in the network.

11. The method according to claim 2, further comprising:
enabling the users of the network to provide rating relating to the commentary added to the media and enabling viewing of the ratings by the users.

12. A system comprising:
a processor; and
a memory storing instructions that, when executed, cause the system to:
receive media for viewing by a plurality of users of a network wherein the media includes at least one of live media and pre-recorded media;
receive commentary added by one or more of the plurality of users to the media at a point, wherein the point is at least one of a group of 1) a selected play-point within the media, 2) a portion within the media, and 3) an object within the media;
store the media and the commentary;
selectively share the commentary with one or more users within the network who are selected by a particular user;
enable viewing of the commentary by the one or the more users with whom the commentary is shared; and
receive a comment on the commentary including at least one of a group of 1) text, 2) a photograph, 3) video, 4) audio, 5) a link to other content, and 6) insertion of text and modification to any visual-based, audio-based, and text-based component of the media.

13. The system according to claim 12, wherein the memory stores further instructions that, when executed, cause the computer to:
process notifications to select users of the network, on the commentary added to the media, wherein the notifications are processed in at least one of the following ways:
receive from users of the network when the users post commentary;
send the notifications when the commentary is added;
provide the notifications for display on a plurality of computing and communication devices; and
provide the notifications via a software mechanism including at least one of a group of email, instant messaging, social network software, software for display on a home screen of a computing or communication device.

14. The system according to claim 12, wherein the memory stores further instructions that, when executed, cause the computer to:
link commentary to particular entities specified by metadata within the media, wherein the media is at least one of video, audio, and text, and an entity in the video includes at least one of a group of 1) a specific actor, 2) a subject, 3) an object, 4) a location, 5) audio content, and 6) a scene in the media, and an entity in the audio includes audio content and a scene, and an entity in the text includes a portion of the text.

15. The system according to claim 14, wherein the metadata is created by at least one of manual and automatic operations, and the automatic operations include at least one of 1) face recognition, 2) speech recognition, 3) audio recognition, 4) optical character recognition, 5) computer vision, 6) image processing, 7) video processing, 8) natural language understanding, and 9) machine learning.

16. The system according to claim 12, wherein the media is at least one of video, audio, or text.

17. The system according to claim 12, wherein the memory stores further instructions that, when executed, cause the computer to:
select and share portions of the media with the commentary with the one or more users within the network who are selected by a particular user.

18. The system according to claim 12, wherein the memory stores further instructions that, when executed, cause the computer to execute at least one of the following:
indicate restrictions on sharing specific portions of the media;
indicate restrictions on at least one of 1) a length, 2) extent, and 3) duration of the media designated for sharing;
indicate restrictions on viewing of a total amount of portions of the media by the one or more users after it is selected for sharing by the particular user.

19. The system according to claim 12, wherein the memory stores further instructions that, when executed, cause the computer to execute at least one of the following:
maintain a record of user consumption history on shared media;
restrict an amount of media for free consumption by a user that is selected for sharing by the particular user; and
restrict an amount of media for consumption by a specific user that is selected for sharing by the particular user.

20. The system according to claim 12, wherein the memory stores further instructions that, when executed, cause the computer to execute at least one of the following:
enable viewing of the media by a particular user with other select users in the network; and
enable the users of the network to provide rating relating to the commentary added to the media and enabling viewing of the ratings by the users.
